(19) United States
(12) Patent Application Publication
(10) Pub. No.: US 2006/0203739 A1
(43) Pub. Date: Sep. 14, 2006

(54) Profiling wide-area networks using peer cooperation

(75) Inventors: Venkata N. Padmanabhan, Bellevue, WA (US); Jitendra D. Padhye, Redmond, WA (US); Narayanan Sriram Ramabhadran, La Jolla, CA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 11/079,792

(22) Filed: Mar. 14, 2005

(51) Int. Cl. H04J 1/16; H04L 12/28

(52) U.S. Cl. 370/252; 370/254

(57) ABSTRACT

End hosts share network performance and reliability information with their peers over a peer-to-peer network. The aggregated information from multiple end hosts is shared in the peer-to-peer network in order for each end host to process the aggregated information so as to profile network performance. A set of attributes defines hierarchies associated with end hosts and their network connectivity. Information on the network performance and failures experienced by end hosts is then aggregated along these hierarchies, to identify patterns (e.g., shared attributes) that are indicative of the source of the problem. In some cases, such sharing of information also enables end hosts to resolve problems by themselves.

### TECHNICAL FIELD

The invention relates generally to peer-to-peer systems in computer network environments and, more particularly, to such systems that enable monitoring and diagnosing of network problems.

### BACKGROUND OF THE INVENTION

In today's networks, network operators (e.g. ISPs, web service providers, etc.) have little direct visibility into a users' network experience at an end hosts of a network connection. Although network operators monitor network routers and links, the information gathered from such monitoring does not translate into direct knowledge of the end-to-end health of a network connection.

For network operators, known techniques of analysis and diagnosis involving network topography leverage information from multiple IP-level paths to infer network health. These techniques typically rely on active probing and they focus on a server-based “tree” view of the network rather than on the more realistic client-based “mesh” view of the network.

Some network diagnosis systems such as PlanetSeer are server-based systems that focus on just the IP-level path to locate Internet faults by selectively invoking active probing from multiple vantage points in a network. Because these systems are server-based, the direction of the active probing is the same as the dominant direction of data flow. Other tools such as NetFlow and Route Explorer enable network administrators to passively monitor network elements such as routers. However, these tools do not directly provide information on the end-to-end health of the network.

On the other hand, users at end hosts of a network connection usually have little information about or control over the components (such as routers, proxies, and firewalls) along end-to-end paths of network connections. As a result, these end-host users typically do not know the causes of problems they encounter or whether the cause is affecting other users as well.

There are tools users employ to investigate network problems. These tools (e.g., Ping, Traceroute, Pathchar, Tulip) typically trace the paths taken by packets to a destination. They are mostly used to debug routing problems between end hosts in the network connection. However, many of these tools only capture information from the viewpoint of a single end host or network entity, which limits their ability to diagnose problems. Also, these tools only focus on entities such as routers and links that are on the IP-level path, whereas the actual cause of a problem might be higher-level entities such as proxies and servers. Also, these tools actively probe the network, generating additional traffic that is substantial when these tools are employed by a large number of users on a routine basis.

Reliance of these user tools on active probing of network connections is problematic for several reasons. First, the overhead of active probing is often high, especially if large numbers of end hosts are using active probing on a routine basis. Second, active probing does not always pinpoint the cause of failure. For example, an incomplete tracing of the path of packets in a network connection may be due to router or server failures, or alternatively could be caused simply by the suppression by a router or a firewall of a control and error-reporting message such as those provided by the Internet Control Message Protocol (ICMP). Third, the detailed information obtained by client-based active probing (e.g., a route tracer) may not pertain to the dominant direction of data transfer, which is typically from the server to the client.

Thus, there is a need for strategies to monitor and diagnose network performance (e.g., communications speeds and failures) from the viewpoint of end hosts in communications paths that do not rely on active probing, and that consider the full end-to-end path of a transaction rather than just the Internet Protocol (IP) level path.

### BRIEF SUMMARY OF THE INVENTION

According to the invention, passive observations of existing end-to-end transactions are gathered from multiple vantage points, correlated and then analyzed to diagnose problems. Information is collected that relates to both performance and reliability. For example, information describing the performance of the connection includes both the speed of the connection and information about the failure of the connection. Reliability information is collected across several connections, but it may include the same type of data such as speed and the history of session failures with particular network resources.

Both short-term and long-term network problems are diagnosed. Short term problems are communications problems likely to be peculiar to the communications session such as slow download times or inability to download from a website. Long term network problems are communications problems that span communications sessions and connections and are likely associated with chronic infrastructure competency such as poor ISP connections to the Internet. Users can compare their long-term network performance, which helps drive decisions such as complaining to the ISP, upgrading to a better level of service, or even switching to a different ISP that appears to be proving better service. For example, a user who is unable to access a website can mine collected and correlated information in order to determine whether the problem sources from his/her site or Internet Service Provider (ISP), or from the website server. In the latter case, the user then knows that switching to a mirror site or replica of the site may improve performance (e.g., speed) or solve the problem (e.g., failure of a download).

Passive observations are made at end hosts of end-to-end transactions and shared with other end hosts in the network, either via an infrastructural service or via peer-to-peer communications techniques. This shared information is aggregated at various levels of granularity and correlated by attributes to provide a database from which analysis and diagnoses are made concerning the performance of the node in the network. For example, a user of a client machine at an end host of the network uses the aggregated and correlated information to benchmark the long-term network performance at the host node against that of other client machines at other host nodes of the network located in the same city. The user of the client machine then uses the analysis of the long-term network performance to drive decisions such as upgrading to a higher level of service (e.g., to 768 Kbps DSL from 128 Kbps service) or switching ISPs.

Commercial endpoints in the network such as consumer ISPs (e.g., America On Line and the Microsoft Network) can also take advantage of the shared information. The ISP may monitor the performance seen by its customers (the end hosts described above) in various locations and identify, for instance, that customers in city X are consistently under performing those elsewhere. The ISP then upgrades the service or switches to a different provider of modem banks, backhaul links and the like in city X in order to improve customer service.

Monitoring ordinary communications allows for “passive” monitoring and collection of information, rather than requiring client machines to initiate communications especially intended for collecting information from which performance evaluations are made. In this regard, the passive collection of information allows for the continuous collection of information without interfering with the normal uses of the end hosts. This continuous monitoring better enables historical information to be tracked and employed for comparing with instant information to detect anomalies in performance.

In keeping with the invention, collected information can be shared among the end hosts in several ways. For example, in one embodiment of the invention, a peer-to-peer infrastructure in the network environment allows for the sharing of information offering different perspectives into the network. Each peer in a peer-to-peer network is valuable, not because of the resources such as bandwidth that it brings to bear but simply because of the unique perspective it provides on the health of the network. With this idea in mind, the greater the number of nodes participating in the peer-to-peer sharing of information collected from the passive monitoring of network communications, the greater number of perspectives into the performance of the network, which in turn is more likely to provide an accurate description of the network's performance. Instead of distributing the collected information in a peer-to-peer network, information can be collected and centralized at a server location and re-distributed to participating end hosts in a client-server scheme. In either case, the quality of the analysis of the collected information is dependent upon the number of end hosts participating in sharing information since the greater the number of viewpoints into the network, the better the reliability of the analysis.

Participation in the information sharing scheme of the invention occurs in several different ways. The infrastructure for supporting the sharing of collected information is deployed either in a coordinated manner by a network operator such as a consumer ISP or the IT department of an enterprise, or it grows on an ad hoc basis as an increasing number of users install software for implementing the invention on their end-host machines.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a block diagram generally illustrating an exemplary computer system of an end host in which the invention is realized;

FIGS. 2a and 2b are schematic illustrations of alternative network environments for the invention;

FIG. 3 is a block diagram illustrating the process of collecting information at each of the end hosts participating in the sharing of information;

FIG. 4 is a flow diagram of the sensing function provided by one of the sensors at an end host that allows for the collection of performance information;

FIG. 5 illustrates signal flow at the TCP level sensed by one of the sensors at an end host that determines round trip times (RTTs) for server-client communications;

FIG. 6 illustrates signal flow at the TCP level sensed by one of the sensors at an end host that identifies sources of speed constraints on communications between an end host and a server;

FIG. 7 is a flow diagram of the sensing function provided by a sensor at an end host that allows for the collection of performance information in addition to that provided by the sensor of FIG. 4;

FIG. 8 illustrates a technique for estimating round trip times (RTTs) in a network architecture such as illustrated in FIG. 2b and implemented in the flow diagram of FIG. 7, wherein a proxy server is interposed in communications between an end host and a server;

FIG. 9 illustrates an exemplary hierarchal tree structure for information shared by end hosts in the network in keeping with the invention;

FIG. 10 is a block diagram illustrating the process of analyzing information collected at an end host using the information shared by other end hosts in communications sessions to provide different viewpoints into the network;

FIG. 11 illustrates an exemplary hierarchical tree structure for sharing information in a peer-to-peer system based on a distributed information system such as distributed hash tables;

FIG. 12 is a schematic illustration of the databases maintained at each end host in the network that participates in the sharing of performance information in accordance with the invention; and

FIGS. 13a and 13b are exemplary user interfaces for the processes that collect and analyze information.

### DETAILED DESCRIPTION OF THE INVENTION

Turning to the drawings, wherein like reference numerals refer to like elements, the invention is illustrated as implemented in a suitable computer networking environment. The networking environment is preferably a wide area network such as the Internet. In order for information to be shared among host nodes, the network environment includes an infrastructure for supporting the sharing of information among the end hosts. In the illustrated embodiment described below, a peer-to-peer infrastructure is described. However, other infrastructures could be employed as alternatives—e.g., a server-based system that aggregates data from different end hosts in keeping with the invention. In the simplest implementation, all of the aggregated information is maintained at one server. For larger systems, however, multiple servers in a communications network would be required.

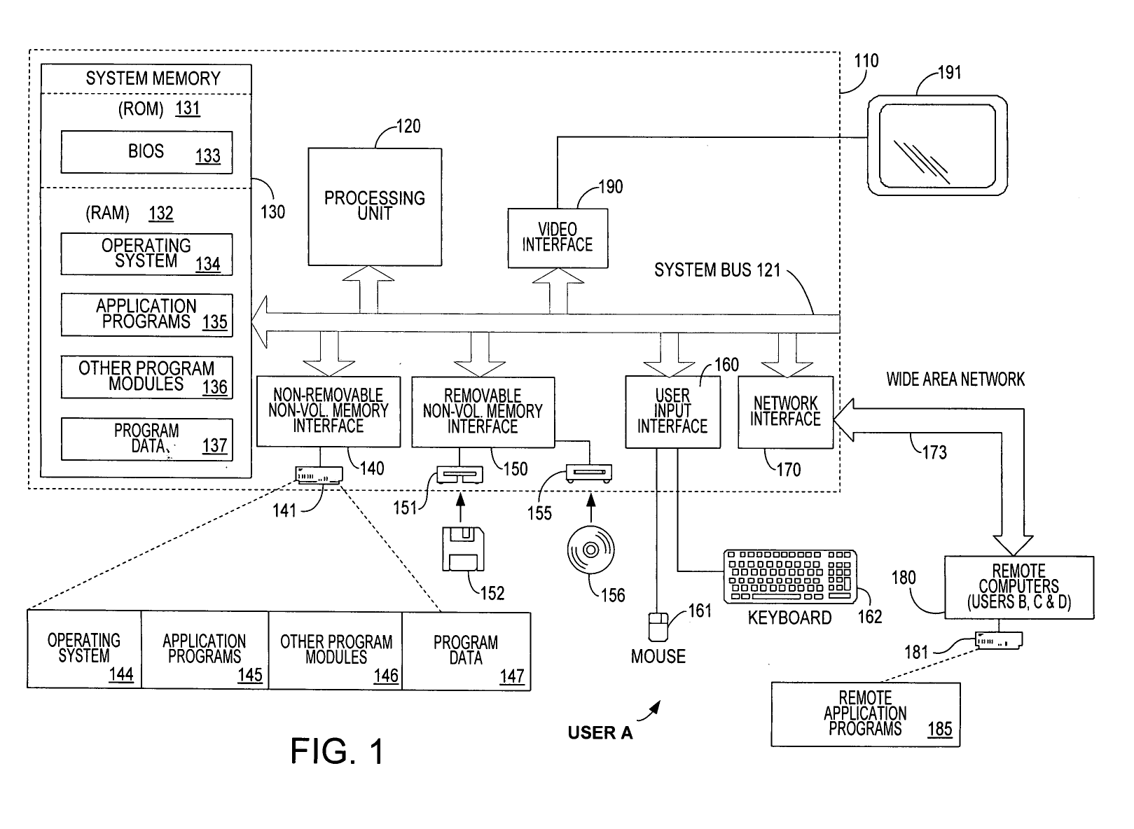

FIG. 1 illustrates an exemplary embodiment of a end host that implements the invention by executing computer-executable instructions in program modules 136. In FIG. 1, the personal computer is labeled “USER A.”

Generally, the program modules 136 include routines, programs, objects, components, data structures and the like that perform particular tasks or implement particular abstract data types. Alternative environments include distributed computing environments where tasks are performed by remote processing devices linked through a wide area network (WAN) such as illustrated in FIG. 1. In a distributed computing environment, program modules 136 may be located in both the memory storage devices of the local machine (USER A) and the memory storage devices of remote computers (USERS B, C, D).

The end host can be a personal computer or numerous other general purpose or special purpose computing system environments or configurations. Examples of suitable computing systems, environments, and/or configurations include, but are not limited to, personal computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

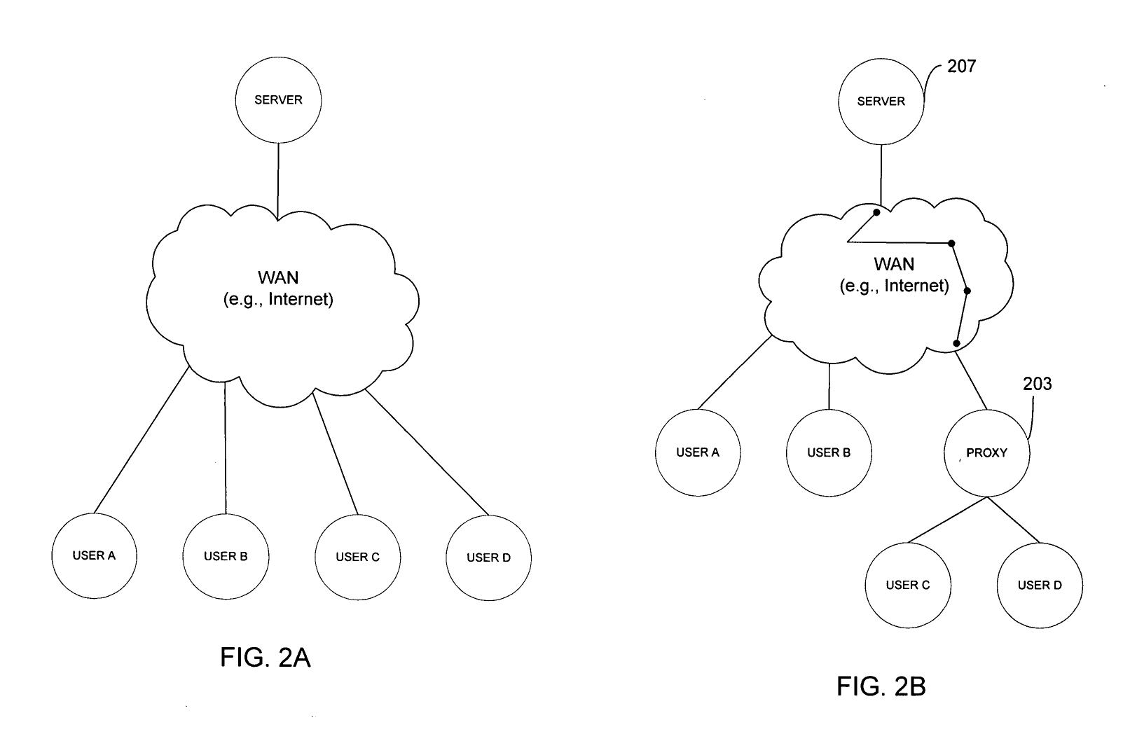

Referring to FIGS. 2a and 2b, USERS A, B, C and D are end hosts in a public or private WAN such as the Internet. The USERS A, B, C and D communicate with nodes in the network such as the server illustrated in FIG. 2a and 2b. The USERS may be either directly coupled into the WAN through an ISP as illustrated in FIG. 2a or the USERS can be interconnected in a subnet (e.g., a corporate LAN) and connected to the WAN through a proxy as illustrated in FIG. 2b.

In either of the environments of FIGS. 2a or 2b, a communications infrastructure in the WAN environment enables the USERS A, B, C, and D to share information. In the embodiment described herein, the infrastructure is a peer-to-peer network, but it could alternatively be a server-based infrastructure. In either case, at each of the USERS A, B, C and D, an application program 135 running in memory 132 passively collects data derived from monitoring the activity of other application programs 135 and stores the data as program data 137 in memory 130. Historical data is maintained as program data 147 in non-volatile memory 140. The monitoring program simply listens to network communications generated during the course of the client's normal workload. The collected data is processed and correlated with attributes of the client machine in order to provide contextual information describing the performance of the machine during network communications. This performance information is shared with other end hosts in the network (e.g., USERS B, C and D) in a manner in keeping with either a peer-to-peer or server-based infrastructure to which the USERS A, B, C and D belong. In a peer-to-peer infrastructure, order to manage the distribution of the performance information among the participating nodes, distributed hash tables (DHTs) manage the information at each of the USERS A, B, C and D.

The exemplary system for one of the USERS A, B, C or D in FIG. 1 includes a general-purpose computing device in the form of a computer 110. Components of computer 110 include, but are not limited to, a processing unit 120, a system memory 130, and a system bus 140 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Associate (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes nonvolatile memory such as read only memory (ROM) 131 and volatile memory such as random access memory (RAM) 132. A basic input/output system 133 (BIOS), containing the basic routines that help to transfer information between elements within computer 110, such as during start-up, is typically stored in ROM 131. RAM 132 typically contains data and/or program modules such as those described hereinafter that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. For example, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. These components can either be the same as or different from operating system 134, application programs 135, other program modules 136, and program data 137. Operating system 144, application programs 145, other program modules 146, and program data 147 are given different numbers hereto to illustrate that, at a minimum, they are different copies. A USER may enter commands and information into the computer 110 through input devices such as a keyboard 162 and pointing device 161, commonly referred to as a mouse, trackball or touch pad. These and other input devices are often connected to the processing unit 120 through a USER input interface 160 coupled to the system bus, but may be connected by other interface and bus structures, such as a parallel port, game port or a universal serial bus (USB). A monitor 191 or other type of display device is also connected to the system bus 121 via an interface, such as a video interface 190.

The computer 110 operates in a networked environment using logical connections to one or more remote computers, such as a remote computer 180 (e.g., one of USERS B, C or D). The remote computer 180 is a peer device and may be another personal computer and typically includes many or all of the elements described above relative to the personal computer 110, although only a memory storage device 181 has been illustrated in FIG. 1. The logical connections depicted in FIG. 1 include the wide area network (WAN) 173 in keeping with the invention, but may also include other networks such as a local area network if the computer 110 is part of a subnet as illustrated in FIG. 2b for USERS C and D. Such networking environments are commonplace in offices, enterprise-wide computer networks, intranets and the Internet.

The personal computer 110 is connected to the WAN 173 through a network interface or adapter 170. In a peer-to-peer environment, program modules at each of the USERS A, B, C and D implement the peer-to-peer environment. FIG. 1 illustrates remote application programs 185 as residing on memory device 181 of the remote computer B, C or D.

There are several aspects of the invention described in detail hereinafter and organized as follows: First, data is collected at user nodes of a network. The data records network activity from the perspective of the user machines. Second, the data is then normalized so it can be shared with other user nodes. Each node participating in the system collects information from other nodes, giving each node many perspectives into the network. In order to compare the data from different nodes, however, it first must be converted to a common framework so that the comparisons have a context. Third, the collected data from different user nodes is aggregated based on attributes assigned to the user nodes (e.g., geography, network topology, destination of message packets and user bandwidth).

With the data collected and organized, each end host instantiates a process for analyzing the quality of its own communications by comparing data from similar communications shared by other end hosts. The process for analysis has different aspects and enables different types of diagnoses.

I. Data Acquisition

Sensors perform the task of acquiring data at each USER node A, B, C and D participating in the information-sharing infrastructure of the invention. Each of the sensors is preferably one of the program modules 136 in FIG. 1. These sensors are primarily intended to passively observe existing network traffic; however, the sensors are also intended to be able to generate test messages and observing their behavior (i.e., active monitoring of performance). Each of the USERS A, B, C and D typically has multiple sensors—e.g., one for each network protocol or application. Specifically, sensors are defined for each of the common Internet protocols such as TCP, HTTP, DNS, and RTP/RTCP as well protocols that are likely to be of interest in specific settings such as enterprise networks (e.g., the RFC protocol used by Microsoft Exchange servers and clients). The sensors characterize the end-to-end communication (success/failure, performance, etc.) as well as infer the conditions on the network path.

A. Examples Of Sensors For Data Acquisition

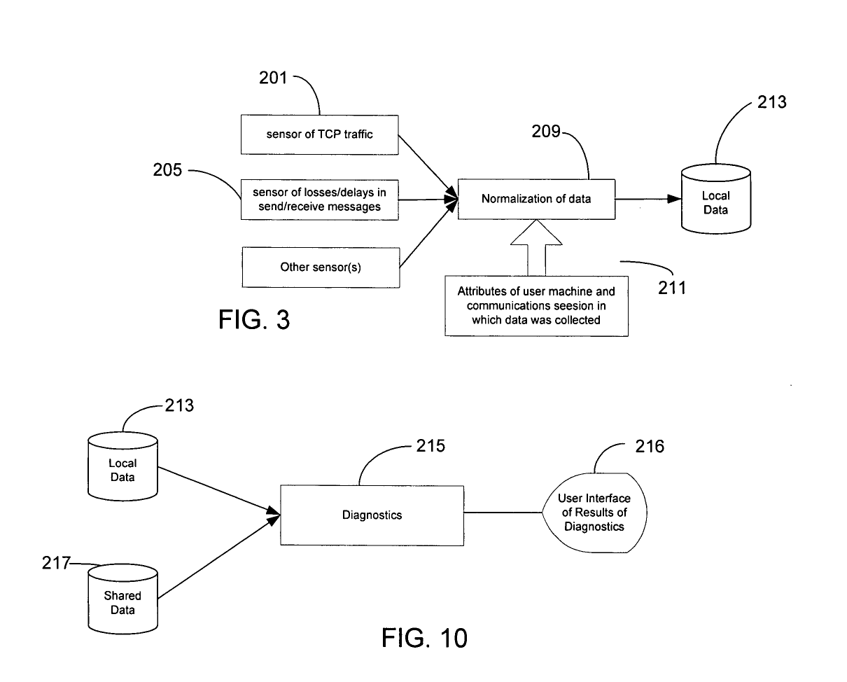

By way of example, two simple sensors are described hereafter to analyze communications between nodes in a network at the TCP and HTTP levels. These sensors are generally implemented as software devices and thus they are separately depicted in the hardware diagram of FIG. 1. Moreover, in the illustrated embodiment of the drawings FIGS. 1-13, two specific sensors are illustrated and described hereinafter in detail. However, many different types of sensors may be employed in keeping with the invention, depending on the specific network environment and the type of information desired to be collected. The widespread use of TCP and HTTP protocols, however, makes the two sensors described hereinafter particularly useful for analyzing node and network performance. Nevertheless, a third generic sensor is illustrated in FIG. 3 to ensure an understanding that the type of sensor incorporated into the invention is of secondary importance to collecting information of a type that is usable in a diagnosis.

TCP Sensor

A TCP sensor 201 in FIG. 3 is a passive sensor that listens on TCP transfers to and from the end host (USER A in FIG. 1), and attempts to determine the cause of any performance problems. In a Microsoft Windows XP® operating system environment, for example, it operates at a user level in conjunction with the NetMon or WinDump filter driver. Assuming the USER's machine is at the receiving end of TCP connections, the following is a set of heuristics implemented by the sensor 201.

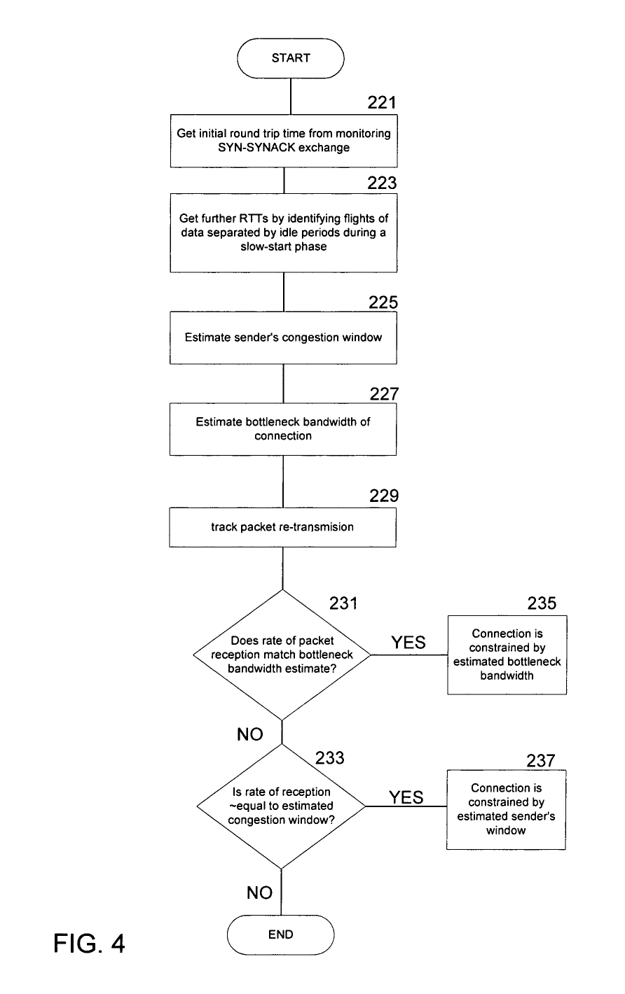

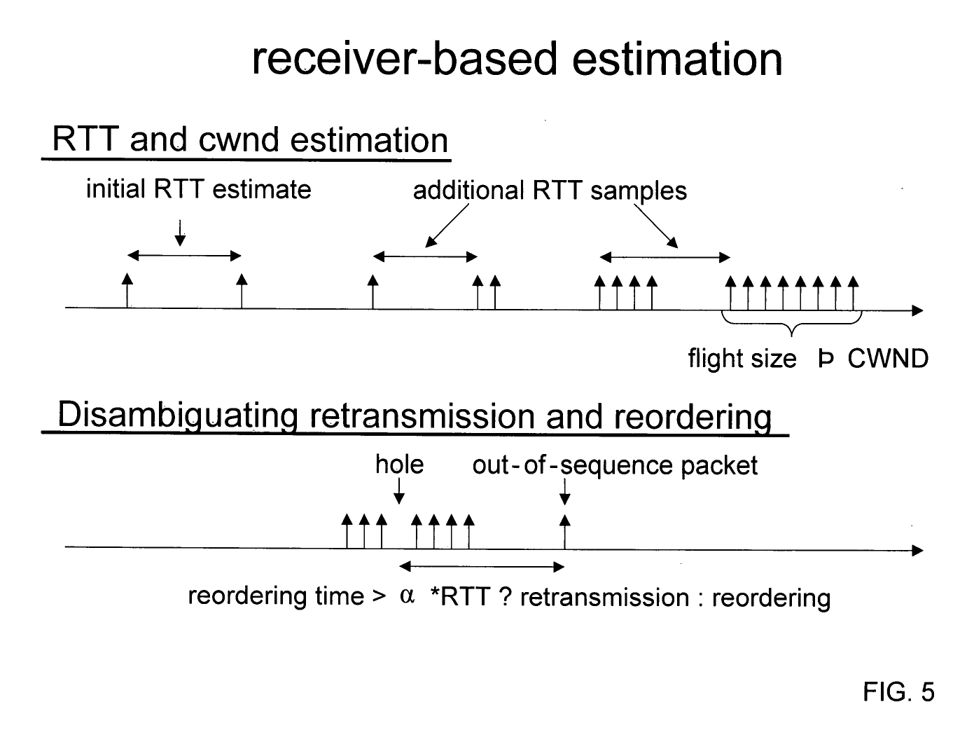

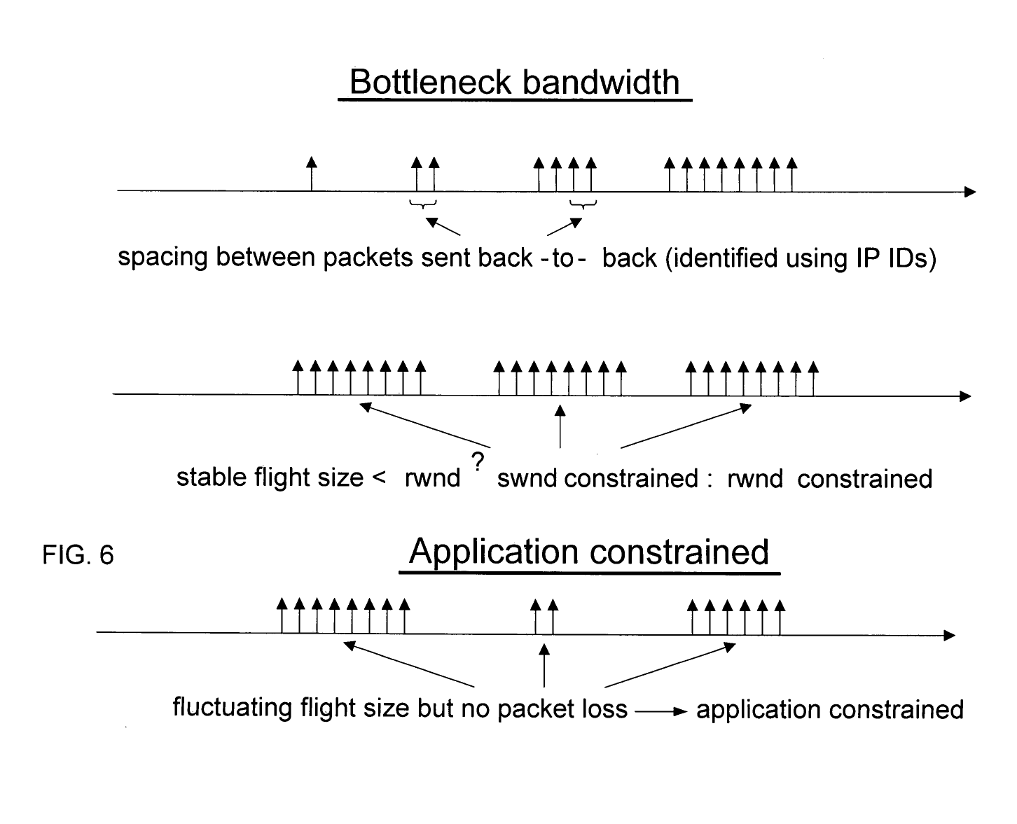

Referring to the flow diagram of FIG. 4, in step 221 an initial round trip time (RTT) sample is obtained from a SYN-SYNACK exchange between the USER and the server (FIG. 2a) as illustrated in the timeline of packet flows in FIG. 5. In step 223 of the flow diagram of FIG. 4, further RTT samples are obtained by identifying flights of data separated by idle periods during a TCP slow-start phase as suggested by the timeline of packet flows in FIG. 5. In step 225 of FIG. 4, the size of a sender's TCP congestion window is estimated based on the RTTs. In step 227, the TCP sensor 201 make a rough estimate of the bottleneck bandwidth (the lowest bandwidth in the path of a connection) by observing the spacing between the pairs of back-to-back packets emitted during TCP slow start as illustrated in the timeline of FIG. 6, which can be identified by checking if the IP IDs are in sequence. In step 229, the TCP sensor 201 senses retransmission of data and the delay caused by the retransmission. The lower timeline in FIG. 5 illustrates measurement of a delay when a packet is received out-of-sequence. Either because of the packet being retransmitted or because the packet experienced an abnormally long transmission delay relative to the other packets.

By the TCP sensor 201 estimating the RTTs, the size of the congestion window and the bottleneck bandwidth, the cause of rate limitation is determined in steps 231 and 233 in the flow diagram of FIG. 4. If the delay matches to the bottleneck bandwidth, then the sensor 201 indicates the connection speed of the monitored communication is constrained by the bottleneck bandwidth in step 235. However, if the delay does not match to the bottleneck bandwidth, the sensor 201 then looks at step 237 to see if the delay matches to the congestion window estimated from the RTTs.

Web Sensor

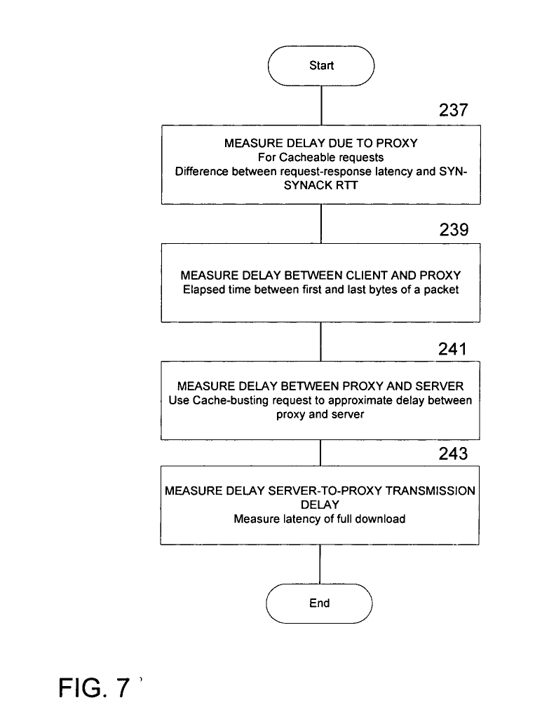

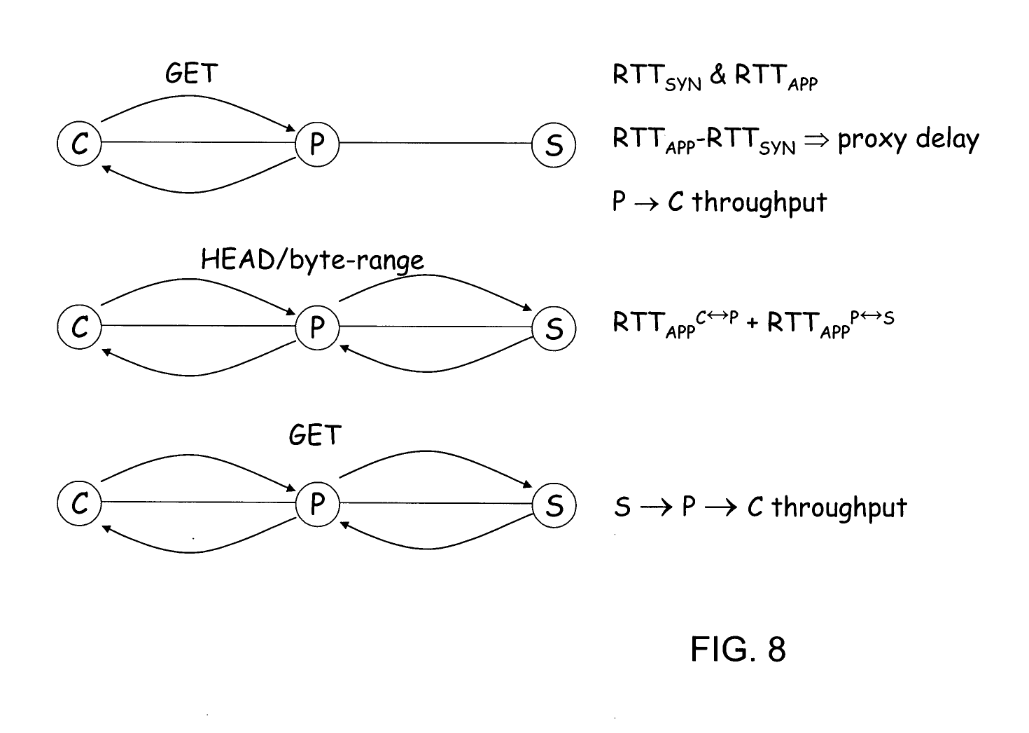

In certain setting such as enterprise networks, a USER's web connections may traverse a caching proxy as illustrated in FIG. 2b. In such situations, the TCP sensor 201 only observes the dynamics of the network path between a proxy 203 and the USER in a connection or communications session (e.g., USER C in FIG. 2b). Another sensor 205 in FIG. 3, herein called a WEB sensor, provides visibility into the conditions of the network path beyond the proxy 203. For an end-to-end web transaction, the WEB sensor 205 estimates the contributions of the proxy 203, a server 207, and the server-proxy and proxy-client network paths to the overall latency. The WEB sensor 205 decomposes the end-to-end latency by using a combination of cache-busting and byte-range requests. Some of the heuristics used by the WEB sensor 205 are outlined in the flow diagram of FIG. 7 and the schematic diagram of FIG. 8.

In general, the elapsed time between the receipt of the first and last bytes of a packet indicates the delay in transmission between the proxy 203 and the client (e.g., USER C), which in general is affected by both the network path and the proxy itself. For cacheable requests, the difference between the request-response latency (until the first byte of the response) and the SYN-SYNACK RTT indicates the delay due to the proxy itself (See diagram a in FIG. 8).
RTT_{APP}−RTT_{SYN}→Proxy Delay
In this regard, the flow diagram of FIG. 7 illustrates the first step 237 of the WEB sensor 205 to measure the transmission delay due to the proxy. In step 239 in FIG. 7, the WEB sensor 205 determines the delay between a USER and the proxy 203 by measuring the elapsed time between the first and last bytes of a transmission.

Next, in order to measure the delay between the proxy 203 and the server 207 (see FIG. 2b), the WEB sensor 205 operates in a pseudo passive mode in step 241 in order to create a large enough request to “bust” through the cache at the proxy 203, thereby eliminating it as a factor in any measured delay. Specifically, the WEB sensor 205 operates by manipulating the cache control and byte-range headers on existing HTTP requests. Thus, the response time for a cache-busting one-byte byte-range request indicates the additional delay due to the proxy-to-server portion of the communication path. In the last step 243 in FIG. 7, the WEB sensor 205 measures the delay of a full download to the client from the server.

The WEB sensor 205 produces less detailed information than the TCP sensor 201 but nevertheless offers a rough indication of the performance of each segment in the client-proxy-server path. The WEB sensor 205 ignores additional proxies, if any, between the first-level proxy 203 and the origin server 207 (See FIG. 2b), which is acceptable since such proxies are typically not visible to the client (e.g., USER C) and thus the client does not have the option of picking between multiple alternative proxies.

II. Data Normalization

Referring again to FIG. 3, data produced by the sensors 201 and 205 at each node (e.g., USERS A, B, C, and D) is normalized before it is shared with other nodes. The normalization enables shared data to be compared in a meaningful way by accounting for differences among nodes in the collected data. The normalization 209 in FIG. 3 relies on attributes 211 of the network connection at the USER and attributes of the USER's machine itself. For example, the throughput observed by a dialup USER is likely to be consistently lower that the throughput observed by a LAN USER at the same location. Comparison of raw data shared between the two USERS suggests an anomaly, but there is no anomaly when the difference in the connections is taken into account. In contrast, failure to download a web page or a file is information that can be shared without adjustment for local attributes such as the speed of a USER's web access link.

In order to provide meaningful comparisons among diverse USERS, the USERS are divided into a few different bandwidth classes based on the speed of their access link (downlink)—e.g., dialup, low-end broadband (under 250 Kbps), high-end broadband (under 1.5 Mbps) and LAN (10 Mbps and above). USERS determine their bandwidth class either based on the estimates provided by the TCP sensor 201 or based on out-of-band information (e.g., user knowledge).

The bandwidth class of a USER node is included in its set of attributes 211 for the purposes of aggregating certain kinds of information into a local database 213, using the procedure discussed below. Information of this kind includes the TCP throughput and possibly also the RTT and the packet loss rate. For TCP throughput, information inferred by the TCP sensor 201 filters out measurements that are limited by factors such as the receiver-advertised window or the connection length. Regarding the latter, the throughput corresponding to the largest window (i.e., flight) that experienced no loss is likely to be more meaningful than the throughput of the entire connection.

In addition to network connection attributes for normalizing shared information, certain other information collected at the local data store 213 (e.g., RTT) is strongly influenced by the location of the USER. Thus, the RTT information is normalized by including with it information regarding the location of the USER so, when the information is shared, it can be evaluated to determine whether a comparison is meaningful (e.g., are the RTTs measured from USERS in the same general area such as in the same metropolitan area).

Certain other information can be aggregated across all USERS regardless of their location or access link speed. Examples include the success or failure of page downloads and server or proxy loads as discerned from the TCP sensor or the WEB sensor.

Finally, certain sites may have multiple replicas and USERS visiting the same site may in fact be communicating with different replicas in different parts of the network. In order to account for these differences, information is collected on a per replica basis and also collected on a per-site basis (e.g., just an indication of download success or failure). The latter information enables clients connected to a poorly performing replica to discover that the site is accessible via other replicas.

III. Data Aggregation

In keeping with the invention, performance information gathered at individual nodes is shared and aggregated across nodes as suggested by the illustration in FIG. 8. Preferably, a decentralized peer-to-peer architecture is employed, which spreads the burden of aggregating information across all USER nodes.

The process of aggregating information at nodes is based on the set of USER attributes 211. For both fault isolation and comparative analysis for example, performance information collected at the local data store 213 of each USER node is shared and compared among USERS having common attributes or attributes that, if different, complement one another in a manner useful to the analysis of the aggregated information. Some USER attributes of relevance are given below.

A. Geographical Location

Aggregation of information at a USER node based on location is useful for end host and network operators to detect performance trends specific to a particular location. For example, information may be aggregated at a USER node for all users in the Seattle metropolitan area as suggested by the diagram in FIG. 8. However, the information fro the USERS in the Seattle area may not be particularly informative to USERS in the Chicago area. Thus, as illustrated in FIG. 8, there is a natural hierarchal structure to the aggregation of information by location—i.e., neighborhood→city→region→country.

B. Topological Location

Aggregation at nodes based on the topology of the network is also useful for end hosts to determine whether their service providers (e.g., their Internet Service Providers) are providing the best services. Network providers also can use the aggregated information to identify performance bottlenecks in their networks. Like location, topology can also be broken down into a hierarchy—e.g., subnet→point of presence (PoP)→ISP.

C. Destination Site

Aggregation of information based on destination sites enables USERS to determine whether other USERS are successfully accessing particular network resources (e.g., websites), and if so, what performance they are seeing (e.g., RTTs). Although this sort of information is not hierarchical, in the case of replicated sites, information from different destination sites may be further refined based on the actual replica at a resource being accessed.

D. Bandwidth Class

Aggregation of information based on the bandwidth class of a USER is useful for comparing performance with other USERS within the same class (e.g., dial up users, DSL users) as well as comparing performance with other classes of USERS (e.g., comparing dial up and DSL users).

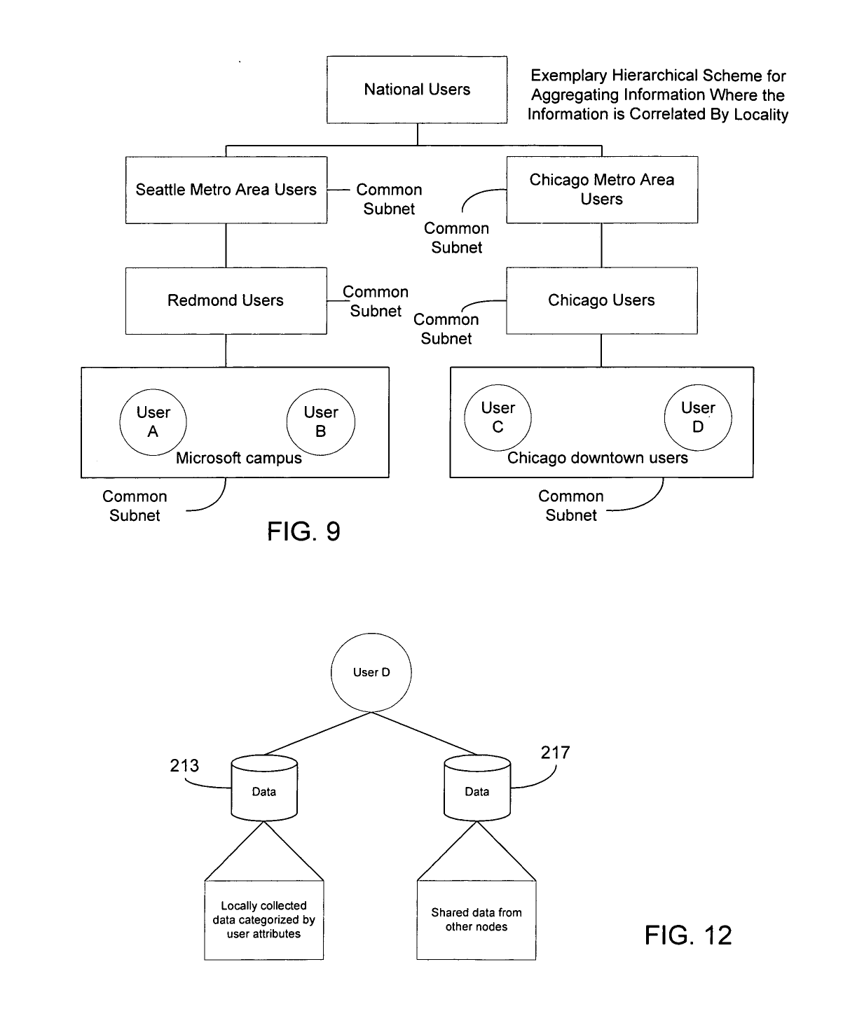

Preferably, aggregation based on attributes such as location and network topology is done in a hierarchical manner, with an aggregation tree logically mirroring the hierarchical nature of the attribute space as suggested by the tree structure for the location attributes illustrated in FIG. 9. USERS at network end hosts are typically interested in detailed information only from nearby peers. For instance, when an end host user is interested in comparing its download performance from a popular website, the most useful comparison is with nodes in the nearby network topology or physical location. Information aggregated from nodes across the country is much less interesting. Thus, the aggregation of the information by location in FIG. 9 builds from a smallest geographic area to the largest. In this regard, a USER at an end host in the network is generally less interested in aggregated views of the performance experienced by nodes at remote physical locations or remote location in the network topology (e.g., the Seattle USERS in FIG. 9 have little interest in information from the Chicago USERS and vice versa). The structure of the aggregation tree in FIG. 9 exploits this generalization to enable the system to scale to a large number of USERS. The above discussion holds true for aggregation based on connectivity as well.

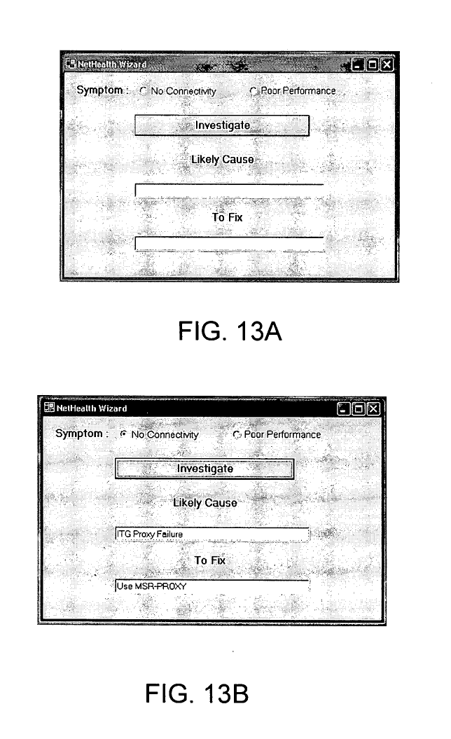

Logical hierarchies of the type illustrated in FIG. 9 may be maintained for each identified attribute such as bandwidth class and destination site and also for pairs of attributes (e.g., bandwidth class and destination site). This structure for organizing the aggregated information enables diagnostics 215 in FIG. 10 at participating USER nodes in a system to provide more fine-grained performance trends based on cross-products of attributes (e.g., the performance of all dialup clients in Seattle while accessing a particular web service). A user interface 216 provides the USER with the results of the processes performed by the diagnostics 215. An exemplary layout for the interface 216 is illustrated in FIG. 13 and described hereinafter. The hierarchy illustrated in FIG. 9 is on an example of the hierarchies that can be implemented n keeping with the invention. Other hierarchies fore example may not incorporate common subnets of the type illustrated in FIG. 9.

Since the number of bandwidth classes is small, it is feasible to maintain separate hierarchies for each class.

In the case of destination sites, separate hierarchies are preferably maintained only for very popular sites. An aggregation tree for a destination hierarchy (not shown) is organized based on geographic or topological locations, with information filtered based on the bandwidth class and destination site attributes. In the case of less popular destination sites, it may be infeasible to maintain per-site trees. In such situations, only a single aggregated view of a site is maintained. In this approach, the ability to further refine based on other attributes is lost.

Information is aggregated at a USER node using any one of several known information management technologies such as distributed hash tables (DHT), distributed file systems or a centralized lookup tables. Preferably, however, DHTs are used as the system for distributing the shared information since they yield a natural aggregation hierarchy. A distributed hash table or DHT is a hash table in which the sets of pairs (key, value) are not all kept on a single node, but are spread across many peer nodes, so that the total table can be much larger than any single node may accommodate.

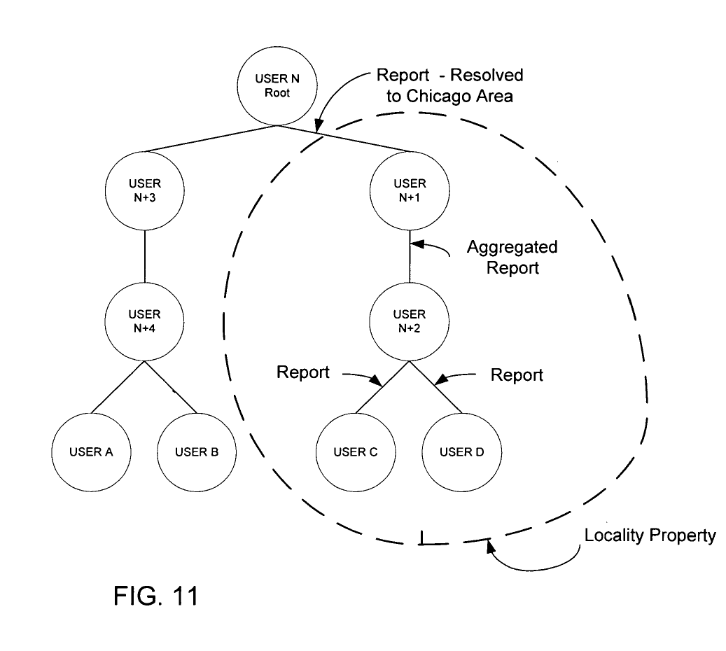

FIG. 11 illustrates an exemplary topology for distributing the shared information in a manner that complements the hierarchical nature of the aggregated information. The tree structure relating the DHTs at each USER node allows for each node to maintain shared information that is most relevant to it such as information gathered from other USERS in the same locality while passing on all information to a root node N that maintains a full version of the information collected from all of the branches of the tree structure.

Each USER node in the hierarchical tree of FIG. 11 maintains performance information for that node and shared information (in database 217 in FIG. 10 and 12) derived from any additional nodes further down the tree (i.e., the subtree defined by USER nodes flowing from any node designated as the root node). Each USER nodes stores the locally collected information that has been normalized in the database 213 illustrated in FIGS. 3 and 12. Periodically, each USER node reports aggregated views of information to a parent node.

Each attribute or combination of attributes for which information is aggregated maintains its own DHT tree structure for sharing the information. This connectivity of the nodes in the DHT ensures that routing the performance report towards an appropriate key (e.g., the node N in FIG. 11), which is obtained by hashing the attribute (or combination of attributes), the intermediate nodes along the path will act as aggregators. In addition, DHTs ensure good locality properties, which may be important to ensure that the aggregator node for a subnet lies within that subnet, for example, as shown in FIG. 11.

IV. Analysis and Diagnosis

A. Distributed Blame Allocation

USERS experiencing poor performance diagnose the problem using a procedure in the diagnostics 215 in FIG. 10 called “distributed blame allocation.”

First, the analysis assumes the cause of the problem is one or more of the entities involved in the end-to-end transaction suffering from the poor performance. The entities typically include the server 207, proxy 203, domain name server (not shown) and the path through the network as illustrated in FIG. 2b. The latency of the domain name server may not be directly visible to a client if the request is made via a proxy.

The resolution of the path depends on the information available (e.g., the full AS-level path or simply the ISP/PoP to which the client connects). To implement the assumption, the simplest policy is for a USER to ascribe the blame equally to all of the entities. But a USER can assign blame unequally if it suspects certain entities more than others based on the information gleaned from the local sensors such as the TCP and WEB sensors 201 and 205, respectively.

This relative allocation of blame is then aggregated across USERS. The aggregate blame assigned to an entity is normalized to reflect the fraction of transactions involving the entity that encountered a problem. The entities with the largest blame score are inferred to be the likely trouble spots.

The hierarchical scheme for organizing the aggregated information naturally supports this distributed blame allocation scheme. Each USER relies on the performance it experiences to update the performance records of entities at each level of the information hierarchy. Given this structure, finding the suspect entity is then a process of walking up the hierarchy of information for an attribute while looking for the highest-level entity whose aggregated performance information indicates a problem (based on suitably-picked thresholds). The analysis reflects a preference for picking an entity at a higher level in the hierarchy that is shared with other USERS as the common cause for an observed performance problem because in general a single cause is more likely than multiple separate causes. For example, if USERS connected to most of the PoPs of a web service are experiencing problems, then it's reasonable to expect s that there is a general problem with the web service itself rather than a specific problem at the individual PoPs.

B. Comparative Analysis

A USER benefits from knowledge of its network performance relative to that of other USERS, especially those within physical proximity of one another (e.g., same city or same neighborhood). Use of this attribute to aggregate information at a USER is useful to drive decisions such as whether to upgrade to a higher level of service or switch ISPs. For instance, a USER whose aggregated data shows he/she is consistently seeing worse performance than others on the same subnet in FIG. 3 (e.g., the same ISP network) and in the same geographic neighborhood has evidence upon which to base a demand for an investigation by the ISP. Without such comparative information, the USER lacks any indication of the source of the problem and has nothing to challenge an assertion by the ISP that the problem is not at the ISP. As another example, a USER who is considering upgrading from low-end to high-end digital subscriber line (DSL) service is able to compare notes with existing high-end DSL users in the same geographic area and determine how much improvement an upgrade may actually be realized, rather than simply going by the speed advertised by the ISP.

At higher levels in the aggregation of information in FIG. 3, service providers are enabled to analyze the network infrastructure in order to isolate performance problems. For example, a consumer ISP that buys infrastructural services such as modem banks and backhaul bandwidth from third-party providers monitors the performance experienced by its customers in different locations such as Seattle and Chicago in FIG. 3. The ISP may find, for instance, that its customers in Seattle are consistently underperforming customers in Chicago, giving it information from which it could reasonably suspect the local infrastructure provider(s) in Seattle are responsible for the problem.

C. Network Engineering Analysis

A network operator can use detailed information gleaned from USERS participating in the peer-to-peer collection and sharing of information as described herein to make an informed decision on how to re-engineer or upgrade the network. For instance, an IT department of a large global enterprise tasked with provisioning network connectivity for dozens of corporate sites spread across the globe has a plethora of choices in terms of connectivity options (ranging from expensive leased lines to the cheaper VPN over the public Internet alternative), service providers, bandwidth, etc. The department's objective is typically to balance the twin goals of low cost and good performance. While existing tools and methodologies (e.g., monitoring link utilization) help to achieve these goals, the ultimate test is how well the network serves end hosts in their day-to-day activities. Hence, the shared information from the peer-to-peer network complements existing sources of information and leads to more informed decisions. For example, significant packet loss rate coupled with the knowledge that the egress link utilization is low points to a potential problem with a chosen service provider and suggests switching to a leased line alternative. Low packet loss rate but a large RTT and hence poor performance suggests setting up a local proxy cache or Exchange server at the site despite the higher cost compared to a central server cluster at the corporate headquarters.

The aggregated information is also amenable to being mined for generating reports on the health of wide-area networks such as the Internet or large enterprise networks.

V. Experimental Results

An experimental setup consisted of a set of heterogeneous USERS that repeatedly download content from a diverse set of 70 web sites during a four-week period. The set of USERS included 147 PlanetLab nodes, dialup hosts connected to 26 PoPs on the MSN network, and five hosts on Microsoft's worldwide corporate network. The goal of the experiment was to emulate a set of USERS sharing information to diagnose problems in keeping with the description herein.

During the course of the experiment, several failure episodes were observed during which accesses to a website failed at most or all of the clients. The widespread impact across USERS in diverse locations suggests a server-side cause for these problems. It would be hard to make such a determination based just on the view from a single client.

There are significant differences in the failure rate observed by USERS that are seemingly “equivalent.” Among the MSN dialup nodes, for example, those connected to PoPs with a first ISP as the upstream provider experienced a much lower failure rate (0.2-0.3%) than those connected to PoPs with other upstream providers (1.6-1.9%). This information helps MSN identify underperforming providers and enables it to take the necessary action to rectify the problem. Similarly, USERS at one location have a much higher failure rate (1.65%) than those in another (0.19%). This information enables USERS at the first location to pursue the matter with their local network administrators.

Sometimes a group of USERS shares a certain network problem that is not affecting other USERS. One or more attributes shared by the group may suggest the cause of the problem. For example, all five USERS on a Microsoft corporate network experienced a high failure rate (8%) in accessing a web service, whereas the failure rate for other USERS was negligible. Since the Microsoft USERS are located in different countries and connect via different web proxies with distinct wide area network (WAN) connectivity, the problem is diagnosed as likely being due to a common proxy configuration across the sites.

In other instances, a problem is unique to a specific client-server pair. For example, assume the Microsoft corporate network node in China is never able to access a website, whereas other nodes, including the ones at other Microsoft sites, do not experience a problem. This information suggests that the problem is specific to the path between the China node and the website (e.g., siteblocking by the local provider). If there was access to information from multiple clients in China, the diagnose may be more particular.

FIGS. 13a and 13b illustrate an exemplary user interface for the invention. When a user at an end host experiences communication problems with the network environment, a process is instantiated by the user that analyzes the collected data and provides a diagnosis. In FIG. 13a, the user interface for the process calls the process “NetHealth.” NetHealth analyzes the collected data and provides an initial indication as to whether the problem results from no connection or poor performance of the connection. In FIG. 13b, the process has completed its analysis and the user interface indicates the source of the problem is a lack of connection. Because the connection could fail at several places in the network, the user interface includes a dialog field identifying the likely cause of the problem or symptom and another dialog field that provides a suggestion for fixing the problem given the identified cause.

VI. Deployment Models

There are two deployment models for the invention-coordinated and organic. In the coordinated model, deployment is accomplished by an organization such as the IT department of an enterprise. The network administrator does the installation. The fact that all USERS are in a single administrative domain simplifies the issues of deployment and security. In the organic model, however, USERS install the necessary software themselves (e.g., on their home machines) in much the same way as they install other peer-to-peer applications. The motivation to install the software sources from a USER's desire to obtain better insight into the network performance. In this deployment model, bootstrapping the system is a significant aspect of the implementation.

A. Bootstrapping

To be effective, the invention requires the participation of a sufficient number of USERS that overlap and differ in attributes. In that way meaningful comparisons can be made and conclusions drawn. When a single network operator controls distribution, bootstrapping the system into existence is easy since the IT department very quickly deploys the software for the invention on a large number of USER machines in various locations throughout the enterprise, essentially by fiat.

Bootstrapping the software into existence on an open network such as the Internet is much more involved, requiring USERS to install the software by choice. Because the advantages of the invention are best realized when there are a significant number of network nodes sharing information, starting from a small number of nodes makes it difficult to grow because the small number reduces the value of the data and present and inhibits the desire of others to add the software to USER machines. To help bootstrap in open network environments, a limited amount of active probing (e.g., web downloads that the USER would not have performed in normal course) are employed initially. USERS perform active downloads either autonomously (e.g., like Keynote clients) or in response to a request from a peer. Of course, the latter option should be used with caution to avoid becoming a vehicle for attacks or offending users, say by downloading from “undesirable” sites. In any case, once the deployment has reached a certain size, active probing is turned off.

B. Security

The issues of privacy and data integrity pose significant challenges to the deployment and functioning of the invention. These issues are arguably of less concern in a controlled environment such as an enterprise.

Users may not want to divulge their identity, or even their IP address, when reporting performance. To help protect their privacy, clients could be given the option of identifying themselves at a coarse granularity that they are comfortable with (e.g., at the ISP level), but that still enables interesting analyses. Furthermore, anonymous communication techniques, that hide whether the sending node actually originated a message or is merely forwarding it, could be used to prevent exposure through direct communication. However, if performance reports are stripped of all client-identifying information, only very limited analyses and inference can be performed (e.g., only able to infer website-wide problems that affect most or all clients).

There is also the related issue of data integrity—an attacker may spoof performance reports and/or corrupt the aggregation procedure. In general, guaranteeing data integrity requires sacrificing privacy. However, in view of the likely uses of the invention as an advisory tool, it is probably acceptable to have a reasonable assurance of data integrity, even if not ironclad guarantees. For instance, the problem of spoofing is alleviated by insisting on a two-way handshake before accepting a performance report. The threat of data corruption is mitigated by aggregating performance reports along multiple hierarchies and employing some form of majority voting when there is disagreement.

All of the references cited herein, including patents, patent applications, and publications, are hereby incorporated in their entireties by reference.

In view of the many possible embodiments to which the principles of this invention may be applied, it will be recognized that the embodiment described herein with respect to the drawing figures is meant to be illustrative only and should not be taken as limiting the scope of invention. For example, those of skill in the art will recognize that the elements of the illustrated embodiment shown in software may be implemented in hardware and vice versa or that the illustrated embodiment can be modified in arrangement and detail without departing from the spirit of the invention. Therefore, the invention as described herein contemplates all such embodiments as may come within the scope of the following claims and equivalents thereof.

What is claimed is:

1. A method for analyzing performance and reliability of a network by sharing network performance and reliability information among a plurality of end hosts in the network, the method comprising:
passively monitoring network communications at the end hosts;
collecting information at the end hosts describing network performance and reliability;
sharing information collected at each of the end hosts with other end hosts;
locally aggregating the shared information based on one or more attributes of the end hosts; and
analyzing the aggregated shared information to identify short-term and long-term network problems.

2. The method of claim 1 wherein the passive monitoring of network communications includes monitoring TCP level communications at the end host.

3. The method of claim 1 wherein the collection of performance and reliability information includes collecting information describing the round trip time (RTT) of a transmission exchange with another end host in a communications link.

4. The method of claim 3 wherein the transmission exchange includes TCP SYN and SYNACK signals.

5. The method of claim 1 wherein one of the attributes is a physical location of the end host.

6. The method of claim 1 wherein one of the attributes is a destination address of the network communications.

7. The method of claim 1 wherein the sharing of the information is managed by a distributed hash table system.

8. The method of claim 1 wherein the end hosts communicate in a peer-to-peer system.

9. A computer readable medium having computer executable components modules for analyzing performance of a user machine at an end host in a network environment and sharing performance information with other end hosts in the network environment, the components comprising:
a first component for passively monitoring network communications at the end hosts;
a second component for collecting information at the end hosts describing network performance and reliability;
a third component for sharing information collected at each of the end hosts with other end hosts;
a fourth component for locally aggregating the shared information based on one or more attributes of the end hosts; and
a fifth component for analyzing the aggregated shared information to identify short-term and long-term network problems.

10. The computer readable medium of claim 9 wherein the first component for passive monitoring of network communications includes monitoring TCP level communications at the end host.

11. The computer readable medium of claim 9 wherein the second component for collecting performance and reliability information includes collecting information describing the round trip time (RTT) of a transmission exchange with another end host in a communications link.

12. The computer readable medium of claim 11 wherein the transmission exchange includes TCP SYN and SYNACK signals.

13. The computer readable medium of claim 9 wherein one of the attributes is a physical location of the end host.

14. The computer readable medium of claim 9 wherein one of the attributes is a destination address of the network communications.

15. The computer readable medium of claim 9 wherein the third component for sharing of the information is managed by a distributed hash table system.

16. The computer readable medium of claim 9 wherein the end hosts communicate in a peer-to-peer system.

17. A user interface at an end host of a network connection for diagnosing problems in the network connection comprising:
a dialog box presented in response to a user input intended to initiate a diagnosis; and
the dialog box providing indications of a symptom of a network connection problem, a likely cause of the connection problem and a fix to the problem, assuming the cause.

18. The user interface of claim 17 including a interactive region for initiating a diagnosis.

19. The user interface of claim 17 wherein the indication of the symptom includes at least an alternative of either no connection or poor performance of the connection.

20. The user interface of claim 17 wherein the indications of the likely cause of the connection problem and the fix include a variable display field for displaying a diagnosis and a solution, respectively.
